(19) United States
(12) Patent Application Publication
(10) Pub. No.: US 2025/0110299 A1
(43) Pub. Date: Apr. 3, 2025

(54) OPTICALLY INTERCONNECTED PROCESSOR AND MEMORY MODULES

(71) Applicant: AvicenaTech, Corp., Sunnyvale, CA (US)

(72) Inventors: Robert Kalman, Sunnyvale, CA (US); Sunghwan Min, Sunnyvale, CA (US); Bardia Pezeshki, Sunnyvale, CA (US); Emad Afifi, Sunnyvale, CA (US)

(73) Assignee: AvicenaTech, Corp., Sunnyvale, CA (US)

(21) Appl. No.: 18/904,837

(22) Filed: Oct. 2, 2024

Related U.S. Application Data
(60) Provisional application No. 63/587,403, filed on Oct. 2, 2023.

(51) Int. Cl. G02B 6/42; H04B 10/40; H04B 10/80

(52) U.S. Cl. CPC G02B 6/425; G02B 6/428; H04B 10/40; H04B 10/801

(57) ABSTRACT

Optically interconnected modules may include logic and/or memory blocks and optical transceiver subsystems. The optical transceiver subsystems may include arrays of microLEDs and arrays of photodetectors. The optical transceiver subsystems of each module may be optically coupled to optical transceiver subsystems of other modules. Each module may include a processor and/or memory chips and optical transceiver subsystem chips mounted on a common substrate, and the processor and/or memory chips and the optical transceiver chips may be coupled by die-to-die interfaces.

### CROSS-REFERENCE TO RELATED APPLICATIONS

This application claims the benefit of U.S. Provisional Patent Application No. 63/587,403, filed on Oct. 2, 2023, the disclosure of which is incorporated by reference herein.

### BACKGROUND OF THE INVENTION

Processors, memory, and other integrated circuits (ICs) used in applications like high-performance computing (HPC) and artificial intelligence/machine learning (AI/ML) have input/output (I/O) bandwidth requirements of many terabits per second (Tbps). The performance of systems using these ICs is currently bottlenecked by I/O bandwidth limitations. Notably, processor-to-memory and processor-to-processor bandwidth constraints are limiting the performance of AI/ML and HPC systems in key data center applications.

Various types of high-performance memory (HPM) with high I/O bandwidth have been developed. Currently, the memory with the highest I/O bandwidth is High Bandwidth Memory (HBM). HBM uses vertically stacked memory die with through-silicon vias (TSVs) to maximize memory capacity within a very limited interconnect distance. HBM connects to a processor via a wide (e.g. 1024 lane) HBM bus, typically implemented as a die-to-die (D2D) interconnect on a silicon interposer. The HBM bus length is generally limited by signal integrity constraints to a maximum length of just a few millimeters. This means that the maximum HBM memory capacity accessible by a processor may be limited by the processor's “shoreline” length. This also generally requires the HBM to be very close to a hot processor, which degrades performance of the HBM DRAM due to the need for a higher refresh frequency. The I/O bandwidth of HBM3 variants is pushing beyond 5 Tbps and may increase substantially in future HHBM versions.

### BRIEF SUMMARY OF THE INVENTION

Some embodiments in accordance with aspects of the invention provide a module for optical interconnection, comprising: a logic and/or memory integrated circuit chip; a plurality of optical transceiver subsystems each comprising an integrated circuit chip, an array of microLEDs mounted to a surface of the integrated circuit chip, an array of photodetectors mounted to the surface of the integrated circuit chip, transmitter circuitry integrated in the integrated circuit chip, and receiver circuitry integrated in the integrated circuit chip; an interposer to which the logic or memory block and the plurality of optical transceiver subsystems are mounted; a die-to-die interface coupling the logic or memory block and each of the optical transceiver systems via the interposer; a plurality of arrays of optical fibers, each in a form of a fiber bundle, with a corresponding fiber bundle for each of the optical transceiver subsystems; and a plurality of optical coupling assemblies to couple light between the optical transceiver subsystems and their corresponding fiber bundles. In some embodiments the interposer is a passive interposer. In some embodiments the surface of the integrated circuit chip for each of the optical transceiver subsystems with the array of microLEDs and the array of photodetectors face away from the passive interposer. In some embodiments the integrated circuit chip for each of the optical transceiver subsystems include through surface vias (TSVs) from a surface of the integrated circuit chip opposite the surface with the array of microLEDs and the array of photodetectors extending towards the surface with the array of microLEDs and the array of photodetectors. In some embodiments the surface of the integrated circuit chip for each of the optical transceiver subsystems with the array of microLEDs and the array of photodetectors faces towards the passive interposer. In some embodiments the passive interposer includes apertures about the locations of the arrays of microLEDs and the arrays of photodetectors of the optical transceiver subsystems. In some embodiments the optical coupling assemblies are located in the apertures of the passive interposer.

Some embodiments in accordance with aspects of the invention provide optically interconnected modules, comprising: a first module having a first logic and/or memory integrated blocks and a first plurality of optical transceiver subsystems each comprising an integrated circuit chip, an array of microLEDs mounted to a surface of the integrated circuit chip, an array of photodetectors mounted to the surface of the integrated circuit chip, transmitter circuitry integrated in the integrated circuit chip, and receiver circuitry integrated in the integrated circuit chip, the first logic and/or memory block being coupled to the first plurality of optical transceiver subsystems by die-to-die interfaces; a second module having a second logic and/or memory block and a second plurality of optical transceiver subsystems each comprising an integrated circuit chip, an array of microLEDs mounted to a surface of the integrated circuit chip, an array of photodetectors mounted to the surface of the integrated circuit chip, transmitter circuitry integrated in the integrated circuit chip, and receiver circuitry integrated in the integrated circuit chip, the second logic and/or memory block being coupled to the second plurality of optical transceiver subsystems by die-to-die interfaces; a third module having a third logic and/or memory block and a third plurality of optical transceiver subsystems each comprising an integrated circuit chip, an array of microLEDs mounted to a surface of the integrated circuit chip, an array of photodetectors mounted to the surface of the integrated circuit chip, transmitter circuitry integrated in the integrated circuit chip, and receiver circuitry integrated in the integrated circuit chip, the third logic and/or memory block being coupled to the third plurality of optical transceiver subsystems by die-to-die interfaces; and a plurality of optical fiber bundles coupling the first plurality of optical transceiver subsystems and the second plurality of optical transceiver subsystems, the first plurality of optical transceiver subsystems and the third plurality of optical transceiver subsystems, and the second plurality of optical transceiver subsystems and the third plurality of optical transceiver subsystems. In some embodiments at least one of the first, second, and third logic and/or memory blocks comprises high performance memory and at least one other of the first, second, and third logic and/or memory blocks comprises a processor.

These and other aspects of the invention are more fully comprehended on review of this disclosure.

### BRIEF DESCRIPTION OF THE FIGURES

FIG. 1 is a block diagram of a system of optically interconnected modules, in accordance

with aspects of the invention.

FIG. 2A is a block diagram showing a module including two processors, in accordance with aspects of the invention.

FIG. 2B is a block diagram showing a module with a plurality of high performance memory (HPM) blocks, in accordance with aspects of the invention.

FIG. 2C is a block diagram of a module comprising multiple memory subsystems connected to a switch IC, in accordance with aspects of the invention.

FIG. 3A is a simplified cross-sectional view of an example OTRS, in accordance with aspects of the invention.

FIG. 3B illustrates an example optical coupling assembly, in accordance with aspects of the invention.

FIGS. 4A-D show various embodiments of optically interconnected modules where the optical interfaces face “up” away from the fan-out package substrate, in accordance with aspects of the invention.

FIGS. 5A-D show various embodiments of optically interconnected modules where the optical interface faces “down” through the fan-out package substrate, in accordance with aspects of the invention.

### DETAILED DESCRIPTION

It may be desirable to be able to connect processors to each other and to HPM at data rates of >10 Tbps while allowing the interconnected ICs to be separated by tens or hundreds of centimeters. Preferably this would be accomplished with very low energy per bit, low latency, and low cost. The ability to implement much longer interconnects to HPM would provide a number of benefits, such as: (1) making much more HPM capacity accessible to a processor; (2) physically separating the HPM from a hot processor potentially allows the HPM to be run at lower temperature, increasing its performance; (3) with appropriate architectures, a given HPM die or stack can be accessed by multiple processor in so-called “disaggregated memory” architectures.

Optical interconnects provide the benefit of density and power dissipation that is much less distance-dependent than that of electrical interconnects. The disclosure herein pertains to the use of optical interconnects for connecting high-performance processors to each other and to high-performance memory.

In some embodiments of optically interconnected modules, a first module comprises one or more logic and/or memory ICs and one or more optical transceiver subsystems (OTRSs). The first module is connected, by way of the OTRSs, to one or more other modules by an optical transmission medium. The other modules, in some embodiments each of the other modules, also comprise one or more logic and/or memory ICs and one or more OTRSs, with the OTRSs of the other modules used for connection to the optical transmission medium.

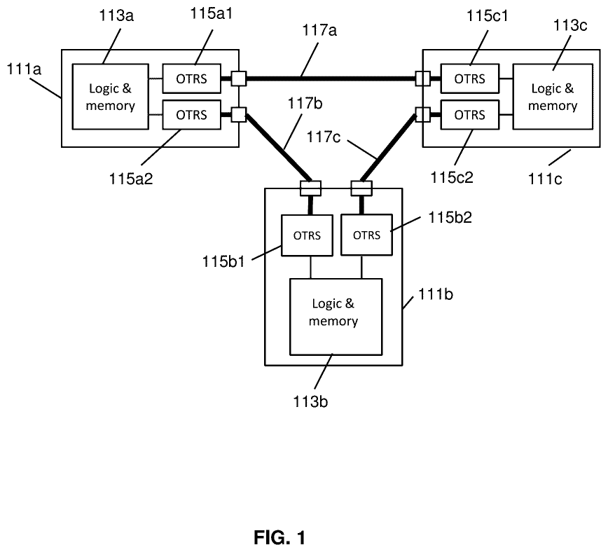

FIG. 1 is a block diagram of a system of optically interconnected modules. The system is shown as including three modules 111a-c. Each of the modules are optically connected to the other modules by way of an optical transmission medium; with a first module 111a and a second module 111b optically connected by way of a first optical transmission medium 117b, the first module optically and a third module optically connected by way of a second optical transmission medium 117a, and the second module and the third module optically connected by way of a third optical transmission medium 117c. In various embodiments there may be a greater number or a fewer number of optically connected modules, and in some embodiments not all of the modules may be optically connected to all of the other modules.

The modules are shown in FIG. 1 as including a logic and memory block 113a-c. In some embodiments some of the modules may instead include a logic block, and in some embodiments some of the modules may instead include a memory block. The modules also include optical transceiver subsystems (OTRS). The OTRS have electrical interfaces with the logic and memory blocks of their modules and optical interfaces with the optical transmission mediums connected to their modules.

In the embodiment of FIG. 1, there is an OTRS at each end of the optical transmission medium. The first module includes an OTRS 115a2 optically coupled to one end of the optical transmission medium 117b and the second module includes an OTRS 115b1 optically coupled to another end of the optical transmission medium 117b. Similarly, the first module includes an

OTRS 115a1 optically coupled to one end of the optical transmission medium 117a and the third module includes an OTRS 115c1 optically coupled to another end of the optical transmission medium 117a. And also similarly, the second module includes an OTRS 115b2 optically coupled to one end of the optical transmission medium 117c and the third module includes an OTRS 115c2 optically coupled to another end of the optical transmission medium 117c.

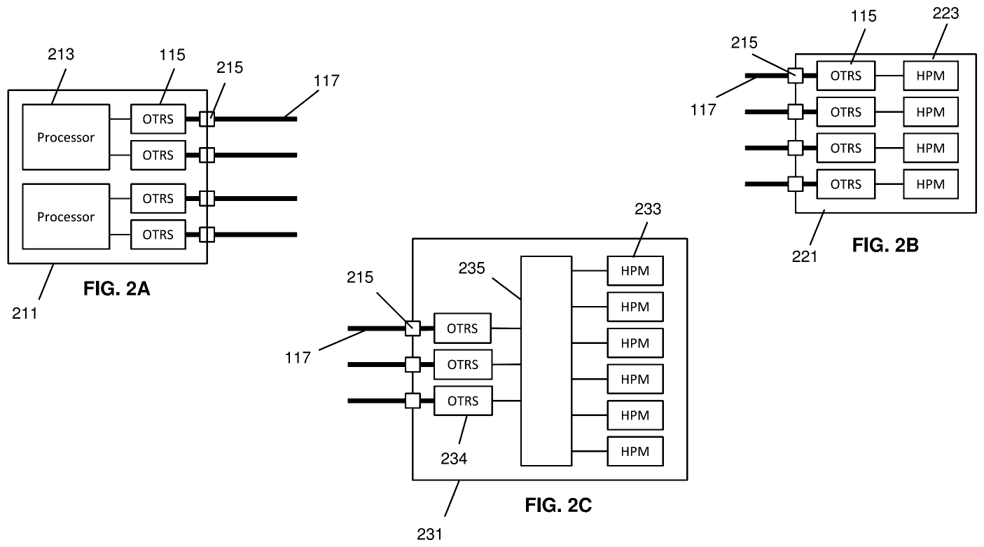

In some embodiments of an optically connected module, a module comprises one or more processor ICs connected to one or more OTRSs. Examples of processor ICs are central processing units (CPUs), a graphics processing units (GPUs), data processing units (DPUs), tensor processing units (TPU), and various specialized processing “accelerators.” FIG. 2A is a block diagram showing a module 211 including two processors 213. The module may be one of the modules of the system of FIG. 1. Each processor is coupled to two OTRS 115. Each OTRS is connected to an optical transmission medium 117 by way of an optical connector 215. In some cases the optical connector is an optical coupling assembly and in some cases the optical connector is an optical connector in-line with the optical transmission medium.

In some embodiments of an optically interconnected module, a module comprises one or more memory subsystems connected to one or more OTRSs. Examples of memory subsystems are High Bandwidth Memory (HBM), synchronous dynamic random access memory (SDRAM), and static random access memory (SRAM). FIG. 2B is a block diagram showing a module with a plurality of high performance memory (HPM) blocks, with four HPM blocks 223 shown in the embodiment of FIG. 2B. In the case of HBM, the memory subsystem comprises stacked DRAM die, and may also comprise a base die that contains buffer circuitry and/or memory controller circuitry. Each HPM block is connected to a corresponding OTRS 115. Each OTRS is connected to an optical transmission medium 117 by way of an optical connector 215. In some the optical connector may be an optical connector in-line with the optical transmission medium.

In some embodiments of an optically connected module, a module comprises one or more logic ICs and one or more memory subsystems connected to one or more OTRSs. As an example, FIG. 2C is a block diagram of a module comprising multiple memory subsystems 233 connected to a switch IC 235. The switch IC is, in turn, connected to one or more OTRSs 234. The switch IC may be, for example, a packet switch or a circuit switch. As one of skill in the art would understand, the switch IC allows for any of the memory subsystems to be connected to any of the OTRSs. Each OTRS is connected to an optical transmission medium 117 by an optical connector 215, which in some cases may be an optical connector in-line with the optical transmission medium.

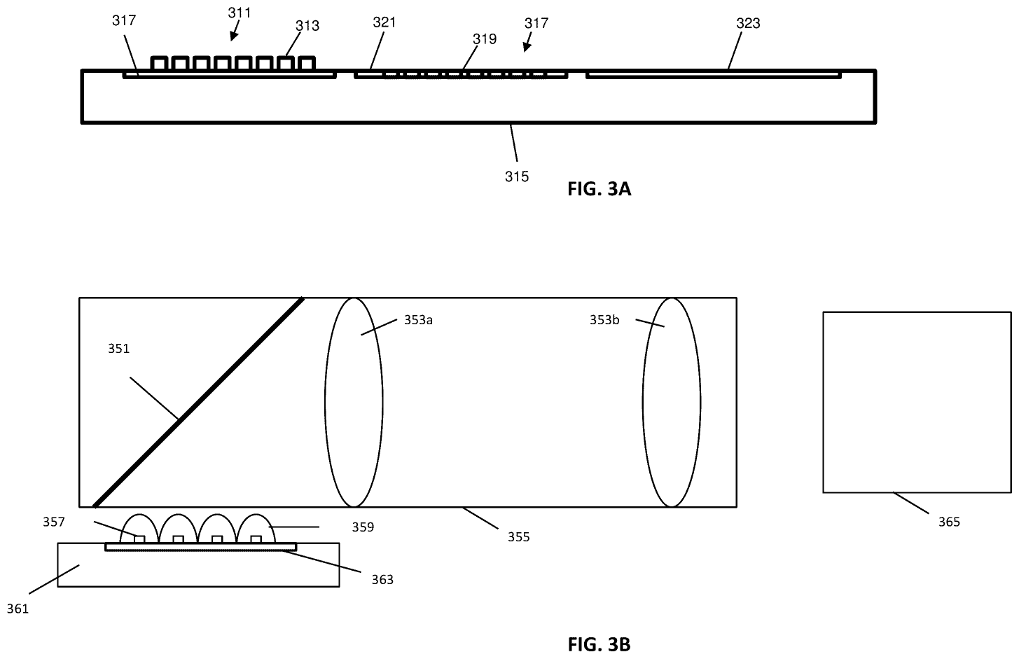

An OTRS comprises one or more optical transmitters (Tx) and/or one or more optical receivers (Rx). FIG. 3A is a simplified cross-sectional view of an example OTRS. In some embodiments, the Tx section comprises a two-dimensional (2D) array of micro-LEDs 311 that are mounted to the surface of an IC 315, in some cases GaN micro-LEDs 313. In some embodiments, the array of microLEDs may be electrically connected to transmitter circuitry 317 integrated in an IC substrate that the array of microLEDs is mounted thereto. In some embodiments, each microLED may be surrounded and encapsulated in a microlens to refract the generated light in a desired direction. In some embodiments, the Rx section comprises a 2D array of photodetectors (PDs) 317, in some cases Si PDs 319 that are integrated into an IC or are mounted to the surface of an IC. In some embodiments, the array of photodetectors may be electrically connected to receiver circuitry 321 integrated in an IC substrate that the array of photodetectors is mounted or integrated thereto. In some embodiments, the array of emitters and the array of PDs are located on some regular grid. In some embodiments, the emitter and PD grids are hexagonal close-packed (HCP), square, or rectangular grids. In some embodiments, the center-to-center spacing of grid elements are in the range of 10 μm-100 μm. In some embodiments, the IC substrate having the transmitter and receiver circuitry and the microLED array and photodetector array mounted or embedded thereto may also have circuitry 323 for other logic functions.

In some embodiments, the optical transmitters and receivers are optically coupled to the transmission medium by an optical coupling assembly. The optical coupling assembly may comprise one or more refractive elements such as lenses and one or more reflective elements such as mirrors. In some embodiments, the reflective elements are 45-degree turning mirrors that change the direction of emitting and receiving light between vertical and horizontal direction. In some embodiments, the one or more refractive elements may focus light on the transmission medium, for example the cores of fiber elements of the transmission medium. In some embodiments, the optical transmitters and receivers are directly butt-coupled to the transmission medium without an intervening optical coupling assembly.

FIG. 3B illustrates an example optical coupling assembly. The optical coupling assembly of FIG. 3B is shown positioned and configured to couple light from microLEDs 357 to an optical fiber 365. In various embodiments the optical coupling assembly may instead or in addition couple light from the optical fiber to photodetectors (not shown in FIG. 3B). In FIG. 3B, the microLEDs are shown as mounted on a semiconductor substrate 361, with transmitter circuitry 363 to drive the microLEDs within the substrate and under the microLEDs. An optional encapsulant 359 is also shown on the substrate, substantially encapsulating the microLEDs. Light from the microLEDs is reflected 45 degrees by a mirror 351 within the optical coupling assembly, so as to direct the light from a vertical direction to a horizontal direction. The light then passes through a pair of lenses 353a,b, before exiting the optical coupling assembly and entering a core of the optical fiber.

In some embodiments, the transmission medium comprises an array of optical fibers in the form of a fiber bundle or an array of optical waveguides. A fiber bundle comprises multiple fiber elements (FEs). Each FE comprises a core surrounded by a concentric cladding layer with a lower index of refraction than the core, enabling the guiding of light in the core. In some embodiments, all FEs have the same nominal dimensions and properties. In some embodiments of an OTRS using an array of micro-LEDs and array of PDs, each micro-LED is optically coupled to one FE in a fiber bundle and each PD is optically coupled to one FE in a fiber bundle. In some embodiments, the one or more refractive elements of the optical coupling assembly may create such one-to-one relation between the microLEDs and fiber elements and the photodetectors and the fiber elements.

In some embodiments, the optical transmission medium comprises an array of planar waveguides. In some embodiments, the optical transmission medium comprises a series of free-space optical elements such as lenses and mirrors that relay light from one or more transmitters to a corresponding set of one or more receivers.

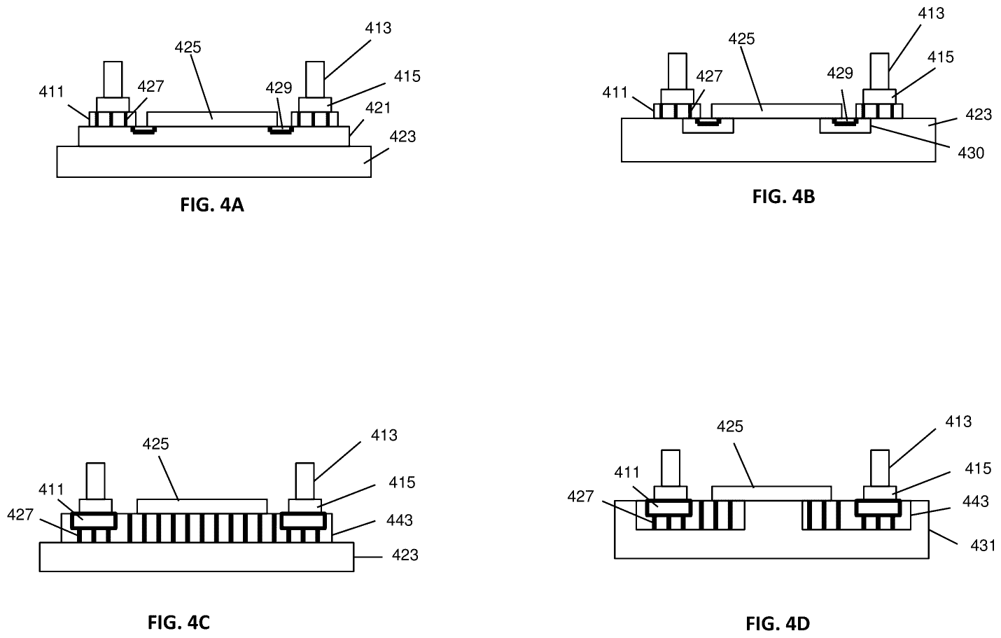

FIGS. 4A-D show various embodiments of optically interconnected modules where the optical interfaces face “up” away from the fan-out package substrate. In some embodiments of an optically interconnected module, one or more logic and/or memory ICs are connected to one or more OTRS ICs via a passive interposer, to which the various ICs are bonded, for instance using flip-chip IC bonding techniques such as C4 bumps, copper pillar bumps or direct bond interconnect (DBI). FIG. 4A shows an embodiment of an optically interconnected module in which one logic and/or memory IC 425 is connected to two OTRS ICs 411 via a die-to-die interface 429 through a passive interposer 421, on which both the logic and/or memory IC and the OTRS ICs are mounted. The logic and/or memory IC and the OTRS IC may be bonded to the passive interposer, for instance using flip-chip IC bonding techniques such as C4 bumps, copper pillar bumps or direct bond interconnect (DBI). Examples of logic ICs that may be used in a module are processor ICs such as CPUs, GPUs, DPUs, and TPUs. Examples of memory are HBM, SDRAM, and SRAM. In some embodiments, the electrical interface between the various ICs may be a die-to-die interface such as UCIe, Open HBI, or Bunch of Wires (BoW). In some embodiments, each of the OTRS ICs are electrically connected to the one or more logic and/or memory ICs using die-to-die interface via the passive interposer. In the case of connecting to HBM, an HBM interface may be used. The optical interfaces (e.g., microLED and photodetector arrays) on each OTRS IC face upward and may be connected to an optical transmission medium 413 via an optical coupling assembly 415 or may be directly coupled to the optical transmission medium. An optical coupling assembly may turn the light at 90° relative to the IC surface or may project light in a straight direction. Each OTRS IC may have through-silicon vias (TSVs) 427 to allow electrical power, ground, and signals to transit through the die. In some embodiments, the passive interposer may be bonded to a fan-out substrate 423, for instance via C4 solder bumps or copper pillar bumps. In some embodiments, the fan-out substrate may be an organic package substrate, a printed circuit board (PCB), or a redistribution layer (RDL) on a molded wafer. A heat sink (not shown in FIG. 4A) may be bonded to the tops of the ICs.

FIG. 4B shows an embodiment of an optically interconnected module that is similar to the embodiment of FIG. 4A except that one or more passive bridge interposers 430 is used for interconnecting the ICs rather than a full interposer. In some embodiments, each bridge interposer is embedded in a cavity in the fan-out substrate 423 and is typically much smaller than the ICs (e.g., logic, memory, and/or OTRS ICs) it is used to interconnect.

FIG. 4C shows an embodiment of an optically interconnected module in which one or more OTRSs are integrated into a base IC 443. One or more logic and/or memory ICs 425 is bonded to the top of the base IC, for instance using conventional flip-chip IC bonding techniques such as copper pillar bumping or direct bond interconnect (DBI). Examples of logic ICs that may be used in a module are processor ICs such CPUs, GPUs, DPUs. Examples of memory are HBM,

SDRAM, and SRAM. The optical interfaces (e.g., microLED and photodetector arrays) on each OTRS 411 face upward and may be connected to a transmission medium via an optical coupling assembly 415 or may be directly coupled to the optical transmission medium 413. An optical coupling assembly may turn the light at 90° relative to the IC surface or may project light in a straight direction. The base IC may have through-silicon vias (TSVs) 427 to allow electrical power, ground, and signals to transit through the die. In some embodiments, the logic and/or memory ICs may be electrically connected to the TSVs of the base IC. In some embodiments, the integrated OTRSs may be electrically connected to the TSVs of the base IC. In some embodiments, the base IC may be bonded to a fan-out substrate 423, for instance via solder bumps or copper pillar bumps. In some embodiments, the logic and/or memory ICs may be electrically connected to the fan-out substrate by the TSVs. In some embodiments, the integrated OTRSs may be electrically connected to the fan-out substrate by the TSVs. In some embodiments, the fan-out substrate may be an organic package substrate, a PCB, or a redistribution layer (RDL) on a molded wafer. In some embodiments, a heat sink may be bonded to the tops of the ICs (e.g., logic, memory, and/or base ICs).

FIG. 4D shows an embodiment of an optically interconnected module that is similar to the embodiment of FIG. 4C, except that multiple base ICs 443, each having at least one OTRS 411, are embedded in cavities of the fan-out substrate (or package substrate) 431 rather than a single base IC mounted to the top of the fan-out substrate. In some embodiments, the logic and/or memory ICs may be directly, but partially, mounted to the fan-out substrate while also being electrically connected to the base ICs, embedded in the fan-out substrate, using TSVs.

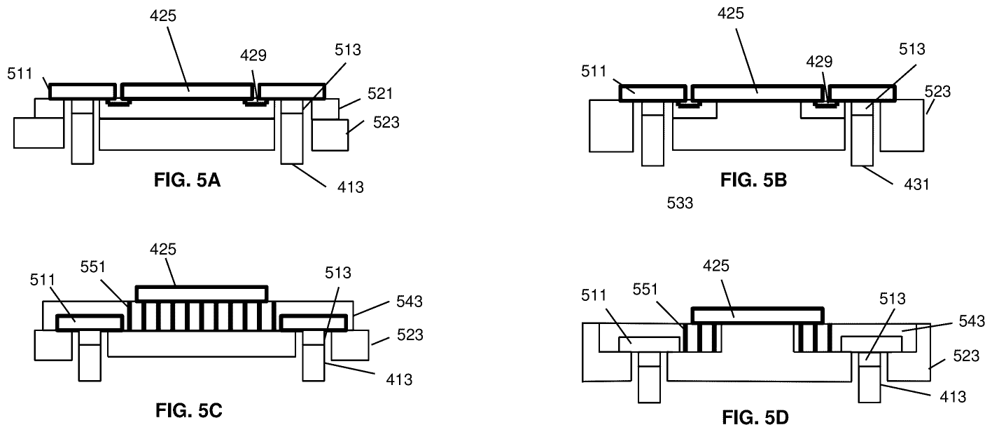

FIGS. 5A-D show various embodiments of optically interconnected modules where the optical interface faces “down” through the fan-out package substrate. FIG. 5A shows an embodiment of an optically interconnected module in which one or more logic and/or memory ICs 425 are connected to one or more OTRS ICs 511 via a passive interposer 521, to which the various ICs are bonded, for instance using conventional flip-chip IC bonding techniques such as copper pillar bumping or direct bond interconnect (DBI). Examples of logic ICs that may be used in a module are processor ICs such CPUs, GPUs, DPUs. Examples of memory are HBM, SDRAM, and SRAM. In some embodiments, the interface between the various ICs may be a die-to-die interface 429 such as UCIe, Open HBI, or Bunch of Wires (BoW). In some embodiments, each of the OTRS ICs may be connected to one or more logic and/or memory ICs using die-to-die interface via the passive interposer. An HBM interface may be used for connecting to HBM. The optical interfaces (e.g., microLED and photodetector arrays) on each OTRS IC face downward and may be connected to an optical transmission medium 413 via an optical coupling assembly 513 or may be directly coupled to the optical transmission medium. An optical coupling assembly may turn the light at 90° relative to the IC surface or may project light in a straight direction. In some embodiments, the passive interposer may be bonded to a fan-out substrate 523, for instance via C4 solder bumps or copper pillar bumps. In some embodiments, the fan-out substrate may be an organic package substrate, a PCB, or a redistribution layer (RDL) on a molded wafer. A heat sink may be bonded to the tops of the ICs. The passive interposer and fan-out substrate have apertures below each OTRS that allow the optical coupling assembly and transmission medium to be attached to the optical interface on the bottom of each OTRS IC.

FIG. 5B shows an embodiment of an optically interconnected module that is similar to the embodiment of FIG. 5A, except that one or more passive bridge interposers 533 is used for interconnecting the ICs rather than a full interposer. Each bridge interposer is embedded in a cavity in the fan-out substrate and is typically much smaller than the ICs (e.g., logic, memory, and/or OTRS ICs) it is used to interconnect. The fan-out substrate has an aperture below each OTRS that allows the optical coupling assembly and transmission medium to be attached to the optical interface on the bottom of each OTRS IC, while the one or more embedded passive bridge interposers may not have such apertures by being to the side of the apertures of the fan-out substrate.

FIG. 5C shows an embodiment of an optically interconnected module in which one or more OTRSs 511 are integrated into a base IC 543. The optical interfaces face “down” from through the fan-out substrate 523. In some embodiments, the OTRS may be located at the bottom of the base IC and contact and be directly mounted to the fan-out substrate. One or more logic and/or memory ICs is bonded to the top of the base IC, for instance using conventional flip-chip IC bonding techniques such as copper pillar bumping or direct bond interconnect (DBI). Examples of logic ICs that may be used in a module are processor ICs such CPUs, GPUs, DPUs. Examples of memory are HBM, SDRAM, and SRAM. The optical interfaces (e.g., microLED and photodetector arrays) on each integrated OTRS face downward and may be connected to a transmission medium via an optical coupling assembly or may be directly coupled to the optical transmission medium. An optical coupling assembly may turn the light at 90° relative to the IC surface or may project light in a straight direction. The base IC may have through-silicon vias (TSVs) 511 to allow electrical power, ground, and signals to transit through the die. In some embodiments, the logic and/or memory ICs may be electrically connected to the TSVs of the base IC. In some embodiments, the base IC may be bonded to a fan-out substrate, for instance via solder bumps or copper pillar bumps. In some embodiments, the logic and/or memory ICs may be electrically connected to the fan-out substrate by the TSVs. In some embodiments, the fan-out substrate may be an organic package substrate, a PCB, or a redistribution layer (RDL) on a molded wafer. The base IC and fan-out substrate have apertures below each OTRS that allow the optical coupling assembly and transmission medium to be attached to the optical interface on the bottom of each OTRS IC. A heat sink may be bonded to the tops of the ICs.

FIG. 5D shows an embodiment of an optically interconnected module that is similar to the embodiment of FIG. 5C except that multiple base ICs 543, each having at least one OTRS, are embedded in cavities of the fan-out substrate 523 rather than a single base IC mounted to the top of the fan-out substrate. In some embodiments, the logic and/or memory ICs may be directly, but partially, mounted to the fan-out substrate while also being electrically connected to the base ICs, embedded in the fan-out substrate, using the TSVs. The fan-out substrate has an aperture below each OTRS that allow an optical coupling assembly and transmission medium to be attached to the optical interface on the bottom of each OTRS IC.

Modules that include memory have many important applications. In the embodiments of FIG. 4C, 4D, 5C, and 5D, a memory controller may be integrated into the base IC(s). In the embodiments of FIG. 4A, 4B, 5A, and 5B, a memory controller may be integrated into the OTRS IC(s).

Although the invention has been discussed with respect to various embodiments, it should be understood that the invention comprises the novel and nonobvious claims supported by this disclosure.

What is claimed is:

1. A module for optical interconnection, comprising:
a logic and/or memory integrated circuit chip;
a plurality of optical transceiver subsystems each comprising an integrated circuit chip, an array of microLEDs mounted to a surface of the integrated circuit chip, an array of photodetectors mounted to the surface of the integrated circuit chip, transmitter circuitry integrated in the integrated circuit chip, and receiver circuitry integrated in the integrated circuit chip;
an interposer to which the logic or memory block and the plurality of optical transceiver subsystems are mounted;
a die-to-die interface coupling the logic or memory block and each of the optical transceiver systems via the interposer;
a plurality of arrays of optical fibers, each in a form of a fiber bundle, with a corresponding fiber bundle for each of the optical transceiver subsystems; and
a plurality of optical coupling assemblies to couple light between the optical transceiver subsystems and their corresponding fiber bundles.

2. The module of claim 1, wherein the interposer is a passive interposer.

3. The module of claim 1, wherein the surface of the integrated circuit chip for each of the optical transceiver subsystems with the array of microLEDs and the array of photodetectors face away from the passive interposer.

4. The module of claim 3, wherein the integrated circuit chip for each of the optical transceiver subsystems include through surface vias (TSVs) from a surface of the integrated circuit chip opposite the surface with the array of microLEDs and the array of photodetectors extending towards the surface with the array of microLEDs and the array of photodetectors.

5. The module of claim 1, wherein the surface of the integrated circuit chip for each of the optical transceiver subsystems with the array of microLEDs and the array of photodetectors faces towards the passive interposer.

6. The module of claim 5, wherein the passive interposer includes apertures about the locations of the arrays of microLEDs and the arrays of photodetectors of the optical transceiver subsystems.

7. The module of claim 6, wherein the optical coupling assemblies are located in the apertures of the passive interposer.

8. Optically interconnected modules, comprising:
a first module having a first logic and/or memory integrated blocks and a first plurality of optical transceiver subsystems each comprising an integrated circuit chip, an array of microLEDs mounted to a surface of the integrated circuit chip, an array of photodetectors mounted to the surface of the integrated circuit chip, transmitter circuitry integrated in the integrated circuit chip, and receiver circuitry integrated in the integrated circuit chip, the first logic and/or memory block being coupled to the first plurality of optical transceiver subsystems by die-to-die interfaces;
a second module having a second logic and/or memory block and a second plurality of optical transceiver subsystems each comprising an integrated circuit chip, an array of microLEDs mounted to a surface of the integrated circuit chip, an array of photodetectors mounted to the surface of the integrated circuit chip, transmitter circuitry integrated in the integrated circuit chip, and receiver circuitry integrated in the integrated circuit chip, the second logic and/or memory block being coupled to the second plurality of optical transceiver subsystems by die-to-die interfaces;
a third module having a third logic and/or memory block and a third plurality of optical transceiver subsystems each comprising an integrated circuit chip, an array of microLEDs mounted to a surface of the integrated circuit chip, an array of photodetectors mounted to the surface of the integrated circuit chip, transmitter circuitry integrated in the integrated circuit chip, and receiver circuitry integrated in the integrated circuit chip, the third logic and/or memory block being coupled to the third plurality of optical transceiver subsystems by die-to-die interfaces; and
a plurality of optical fiber bundles coupling the first plurality of optical transceiver subsystems and the second plurality of optical transceiver subsystems, the first plurality of optical transceiver subsystems and the third plurality of optical transceiver subsystems, and the second plurality of optical transceiver subsystems and the third plurality of optical transceiver subsystems.

9. The optically interconnected modules of claim 8, wherein at least one of the first, second, and third logic and/or memory blocks comprises high performance memory and at least one other of the first, second, and third logic and/or memory blocks comprises a processor.
